(19) United States
(12) Patent Application Publication
(10) Pub. No.: US 2008/0244428 A1
(43) Pub. Date: Oct. 2, 2008

(54) Visually Emphasizing Query Results Based on Relevance Feedback

(75) Inventor: Daniel C. Fain, Los Angeles, CA (US)

Correspondence Address: BAKER BOTTS L.L.P., 2001 ROSS AVENUE, 6TH FLOOR, DALLAS, TX, 75201, US

(73) Assignee: Yahoo! Inc., Sunnyvale, CA (US)

(21) Appl. No.: 11/694,160

(22) Filed: Mar. 30, 2007

(51) Int. Cl. G06F 3/048

(52) U.S. Cl. 715/764

(57) ABSTRACT

An example embodiment of the present invention provides processes for visually emphasizing the displayed URLs in query results based on implicit relevance feedback. In one process, the process identifies a web page which includes results returned by a search engine. Each result might include a displayed URL and an actual URL. The process determines whether the displayed URL matches any stored URLs which were included in previous results returned by the search engine and clicked through by the user. The process detects a click-through by matching the actual URL in an HTTP request emanating from a browser to an actual URL for a stored URL. The process visually emphasizes the displayed URL when presenting the web page to the user, if the displayed URL does not match any stored URL which has been clicked through and other factors indicate a probability the user will click through the displayed URL.

### TECHNICAL FIELD

The present disclosure relates to information retrieval and graphical user interfaces (GUIs) for information-retrieval tools such as search engines.

### BACKGROUND

Relevance feedback is a feature of some information-retrieval systems, such as search engines. The “relevance” referred to is the relevance of query results, e.g., documents or web pages. The “feedback” referred to is feedback from the system's user, not the system.

Conceptually, there are three types of relevance feedback: explicit feedback, implicit feedback, and blind or “pseudo” feedback. One obtains explicit feedback by having the user mark specific query results as relevant or irrelevant. Implicit feedback is inferred from user behavior, such as observing which results a user does or does not select for viewing or observing how long a user views particular results. Observations of the latter type are sometime called “eye tracking”. Blind or “pseudo” relevance feedback is obtained by assuming that the top results in the result set actually are relevant.

Typically, relevance feedback utilizes information about the relevance of query results to perform a new query. So, for example, one might use feedback about relevance to adjust the weight of terms in the original query or use the feedback to add/subtract terms from the query. One might eve log information about query chains or click-throughs to assist in such query reformulation. See F. Radlinski and T. Joachims, Query Chains: Learning to Rank from Implicit Feedback, Proceedings of the ACM Conference on Knowledge Discovery and Data Mining (2005). Others have used relevance feedback to re-rank the query results, in addition to reformulating queries. See Xuehua Shen, Bin Tan, Chengxiang Zhai, UCAIR Toolbar; A Personalized Search Toolbar, Proceedings of 2005 ACM Conference on Research and Development on Information Retrieval (2005) and U.S. Patent Application Publication No. 20060224587.

A problem with re-ranking is reproducibility. If one bases a results display on a query chain, a user who inputs the last query in the chain might not see the same results as a user who inputs the entire chain.

### SUMMARY OF THE INVENTION

In particular embodiments, the present invention provides methods, apparatus, and systems directed to the visual emphasis of query results based on relevance feedback from the user of an information retrieval tool such as a search engine. In a particular embodiment, the relevance feedback is implicit and is gleaned from session history (e.g., previously-returned URLs, click-throughs, etc.) stored in main memory.

### DESCRIPTION OF THE DRAWINGS

FIG. 1 is a diagram showing a network environment for an information retrieval system, which network environment might be used in an embodiment of the present invention.

FIG. 2 is a diagram showing an information retrieval system which supports contextual and personalized search queries, which system might be used in an embodiment of the present invention.

FIG. 3 is a diagram showing the hardware system for a search-engine server or client computing device, which hardware system might be used in an embodiment of the present invention.

FIG. 4 is a diagram showing a flowchart of a process used for storing query results in memory, which process might be used in an embodiment of the present invention.

FIG. 5 is a diagram showing a flowchart of a process used for visually emphasizing query results on the basis of previously-returned URLs, which process might be used in an embodiment of the present invention.

FIG. 6 is a diagram showing a flowchart of a process used for storing click-through data in memory, which process might be used in an embodiment of the present invention.

FIG. 7 is a diagram showing a flowchart of a process used for visually emphasizing query results on the basis of previously-stored click-throughs, which process might be used in an embodiment of the present invention.

### DESCRIPTION OF EXAMPLE EMBODIMENT(S)

The following embodiments are described and illustrated in conjunction with apparatuses, methods, and systems which are meant to be examples and illustrative, not limiting in scope.

### A. Network Environment

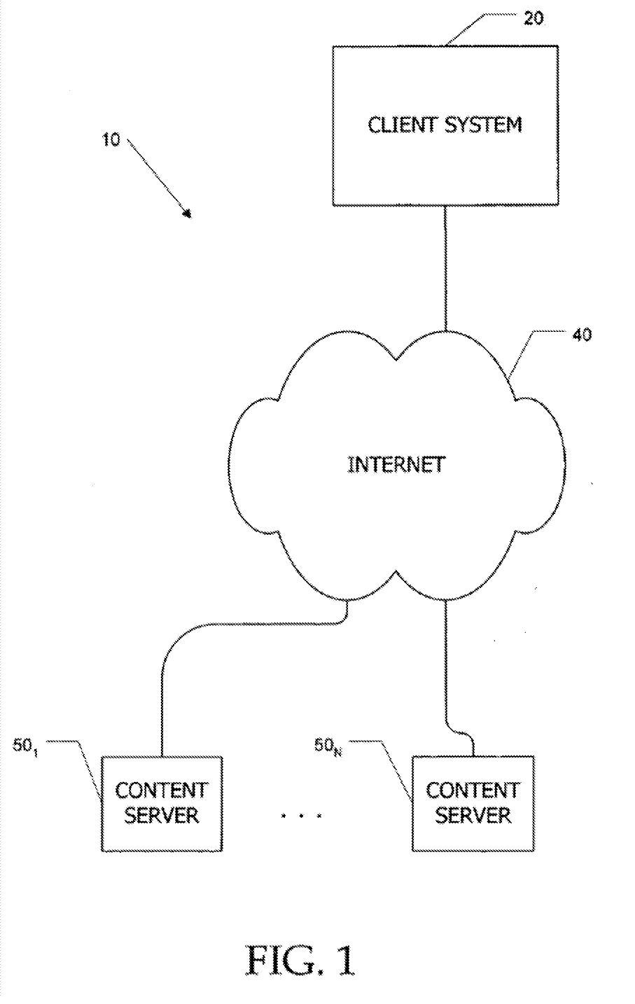

FIG. 1 illustrates a network environment for an information retrieval system, which network environment might be used in an embodiment of the present invention. In computer network 10, client system 20 is connected through the Internet 40, or other communication network, e.g., over any local area network (LAN) or wide area network (WAN) connection, to any number of content server systems 50₁ to 50_{N}. As described below, client system 20 is configured to communicate with any of content server systems 50₁ to 50_{N}, e.g., to access, receive, retrieve, and/or display media content and other information such as web pages.

For purposes of this description, a “web page” comprises any computer file, document, or grouping of electronic text which can be addressed by a hypertext link and rendered for a user on his/her computer monitor. This includes any grouping of electronic text, graphical material, or data generated by a software application and displayed through the use of a web browser or other client application. In some embodiments, such a grouping might make use of Extensible Markup Language (XML), which is a simplified subset of the Standardized Generalized Markup Language (SGML) that provides a file format for representing data, a schema for describing data structure, and a mechanism for extending and annotating HTML with semantic information XML is a format to structure, store, and send information. XML allows the author to define his/her own tags and document structure. XML is not a replacement for HTML. In current and future web developments, it is likely that XML will be used to describe and transfer data and HTML will be used to format and display the same data.

Several elements in the system shown in FIG. 1 include conventional, well-known elements. For example, client system 20 could include a desktop personal computer, workstation, laptop, personal digital assistant (PDA), cell phone, or any WAP (Wireless Application Protocol)-enabled device or any other computing device capable of interfacing directly or indirectly to the Internet. Client system 20 typically runs a browsing program, such as Microsoft's Internet Explorer browser, Mozilla Firefox browser, Netscape Navigator browser. Opera browse, or a WAP-enabled browser in the case of a cell phone, PDA or other wireless device, or the like, allowing a user of client system 20 to access, process, and view information and pages available to it from content server systems 50₁ to 50_{N} over Internet 40.

Client system 20 also typically includes one or more user interface devices, such as a keyboard, a mouse, touch screen, pen or the like, for interacting with a graphical user interface (GUI) provided by the browser in a display (e.g., monitor screen, LCD display, etc.), in conjunction with pages, forms, and other information provided by content server systems 50₁ to 50_{N} or other servers. Particular embodiments of the present invention are suitable for use with the Internet, which refers to a specific global network of networks. However, it will be understood that other networks can be used instead of or in addition to the Internet, such as an intranet, an extranet, a virtual private network (VPN), a non-TCP/IP based network, any LAN or WAN or the like.

According to a particular embodiment, client system 20 and all of its components are configurable and made operative using an application including computer code run using a central processing unit such as Intel Xeon, Intel Core, or the like or multiple microprocessors. Computer code for configuring and operating client system 20 to communicate, process, and display data and media content as described below is preferably downloaded and stored on a hard disk, but the entire program code, or portions thereof, may also be stored in any volatile or non-volatile memory medium or device as is well known, such as a ROM or RAM, or provided on any media capable of storing program code, such as a compact disk (CD) medium, a digital video disk (DVD) medium, a floppy disk, and the like. Additionally, the entire program code, or portions thereof, may be transmitted and downloaded from a software source, e.g., from one of content server systems 50₁ to 50_{N} to client system 20 over the Internet, or transmitted over any other network connection (e.g., extranet, VPN, LAN, or other conventional networks) using any communication medium and protocol (e.g., TCP/IP, HTTP, HTTPS, Ethernet, or other conventional media and protocol).

It will be appreciated that computer code for implementing embodiments of the present invention can be C, C++, HTML, XML, Java, JavaScript, etc., or any suitable scripting language, e.g., VBScript, or any other suitable programming language that can be executed on client system 20 or compiled to execute on client system 20. In some embodiments, no code is downloaded to client system 20, and needed code is executed by a server, or code already present at client system 20 is executed.

### B. Search System

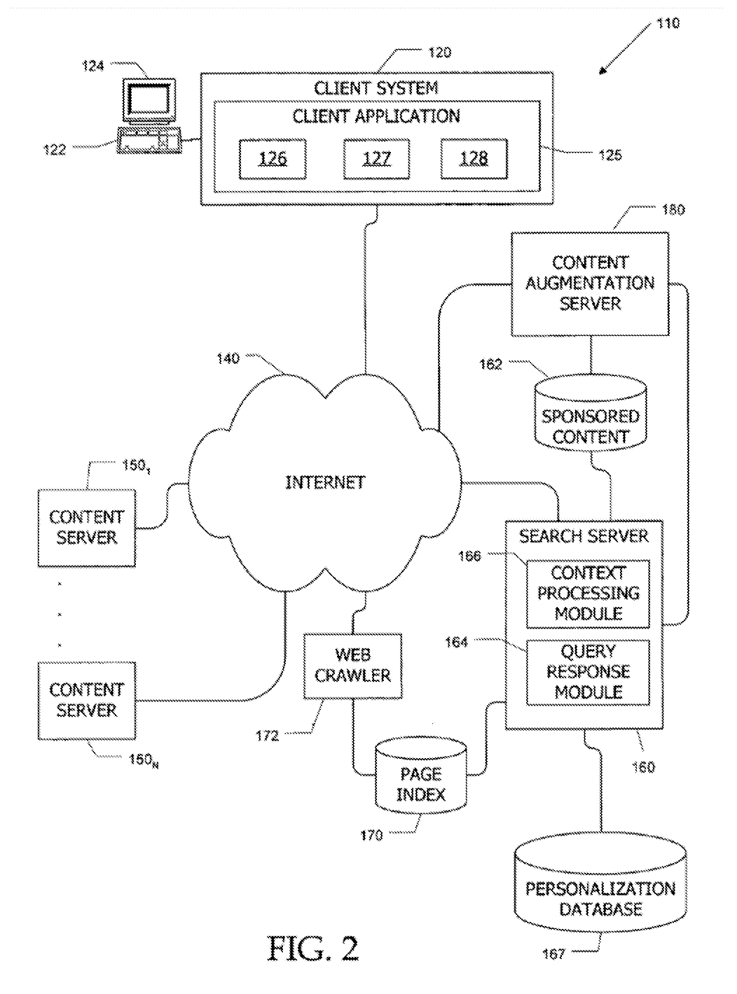

FIG. 2 illustrates an information retrieval system which supports contextual and personalized search queries, which system might be used in an embodiment of the present invention. As shown, network 110 includes client system 120 (which corresponds to client system 20 in FIG. 1), one or more content server systems 150 (which correspond to content server systems 50₁ to 50_{N} in FIG. 1), and a search server system 160. In network 110, client system 120 is connected through Internet 140 or other communication network to server systems 150 and 160. As described earlier, client system 120 and its components might be configured to communicate with server systems 150 and 160 and other server systems over Internet 140 or other communication networks.

### 1. Client-Side System

In a particular embodiment, a client application (represented as module 125) executing on client system 120 includes instructions for controlling client system 120 and its components to communicate with server systems 150 and 160 and to process and display data content received from those serve systems. Client application 125 may be transmitted and downloaded to client system 120 from a software source such as a remote server system (e.g., server systems 150, server system 160, or other remote server system), or client application module 125 may also be provided on any software storage medium (floppy disk, CD, DVD, etc.) that is readable by client system 120. For example, in one embodiment, client application 125 may be provided over Internet 140 to client system 120 in an HTML wrapper including various controls such as, for example, embedded JavaScript or Active X controls, for manipulating data and rendering data in various objects, frames, and windows.

Client application module 125 includes various software modules for processing data and media content. In one embodiment, these modules include a specialized search module 126, a user interface module 127, and an application interface module 128. Specialized search module 126 is configured for processing search request (also referred to herein as queries) to be sent to search server 160 and search result data received from search server 160. Specific embodiments of specialized search module 126 are described below.

User interface module 127 is configured for rendering data and media content in text and data frames and active windows, e.g., browser windows and dialog boxes. In some embodiments, user interface module 127 includes or communicates with a browser program, which may be a default browser configured on client system 120 or a different browser. Application interface module 128 is configured to support interfacing and communicating between client application 125 and various other applications executing on client 120, such as e-mail applications, instant messaging (IM) applications, browser applications, document management applications, and others.

User interface module 127 provides user input interfaces allowing the user to enter queries for processing by search server system 160. For example, where user interface module 127 includes or communicates with a browse, the user may be able to enter a URL or activate a control button to direct the browser to a Web search page (or site) from which the suer can submit a query to search sever system 160 for processing. In addition or instead, user interface module 127 may include a search toolbar or other interface via which the user can enter and submit a query without first navigating to the search page. Queries entered using user interface module 127 may be preprocessed by specialized search module 126 prior to being sent to search server system 160, e.g., to remove so-called “stop words” (“the,” “and,” etc.), to correct spelling errors, or the like.

In a particular embodiment, client application 125 may include various features for adding context information (referred to herein as a “context vector”) to the user's queries. For example, specialized search module 126 may be configured to generate context vectors based on content the user is currently viewing at the time a query is entered. As another example, in some embodiments of the present invention, web pages displayed in the browser may include one or more context vectors that can be used to supplement user-entered queries. User interface module 127 may be configured to detect such contextual vectors in a page being displayed and use context vector data to supplement a query entered by the user. Alternatively, user interface module 127 may be configured to allow the user to enter contextual information in an interface component such as a window.

### 2. Server-Side System

In particular embodiments of the invention, search server system 160 is configured to provide search result data and media content to client system 120, and content server system 150 is configured to provide data and media content such as web pages to client system 120, for example, in response to links selected by the user in search result pages provided by search server system 160. In some variations, search server system 160 returns content as well as, or instead of, links and/or other references to content.

Search server system 160 references various page indexes 170 that are populated with, e.g., page, links to pages, data representing the content of indexed pages, etc. Page indexes may be generated by various collection technologies such as an automatic web crawler 172. In addition, manual or semi-automatic classification algorithms and interfaces may be provided for classifying and ranking web pages within a hierarchical category structure.

In a particular embodiment, an entry in page index 170 includes a search term, a reference (e.g., a URL or other encoded identifier) to a page in which that term appears, and a context identifier for the page. The context identifier may be used for grouping similar results for search terms that may have different meanings in different contexts. For example, the search term “jaguar” may refer to the British automobile, to an animal, to a professional football team, and so on. The context identifier for a page can be used to indicate with of these contexts is applicable. Such use of a context identifier is sometimes called “word/term disambiguation”. In other instances, a user might submit a query such as “canon mp780” which is an unambiguous proper noun. However, the query does not fully reveal the user's intent (e.g., to research, to buy, to upgrade, etc.), though again the intent may be captured in the context identifier. Such use of a context identifier is sometimes called “inferring intent”.

In one embodiment, the context identifier includes a category for the page, with the category being assigned from a predefined hierarchical taxonomy of content categories. A page reference may be associated with multiple context identifiers, so the same page (or a link thereto) may be displayed in multiple contexts. In some embodiments, context identifiers are automatically associated with page links by the system as users perform various searches. The identifiers may also be modified and associated with links manually by a team of one or more index editors.

Search server system 160 is configured to provide data responsive to various search requests received from a client system 120, in particular from search module 126 and/or user interface module 127. For example, search server system 160 may include a query response module 164 that is configured with search related algorithms for identifying and ranking web pages relative to a given query, e.g., based on a combination of logical relevance (which may be measured by patterns of occurrence of search terms in the query), context identifiers, page sponsorship, etc. In particular embodiments, organic search (i.e., search whose result sets are not influenced by sponsorship) comprises some of these algorithms.

In a particular embodiment, query response module 164 is also configured to receive and make use of context vector data that may be provided in association with a query in order to further enhance the response to queries. Query response module 164 may also enhance search result information with additional information (e.g., links and/or advertising copy) obtained from a sponsored context database 162. Sponsored content database 162 may be implemented as part of page index 170 by the inclusion of additional fields in each entry to identify page references that are sponsored and keywords for triggering the display of sponsored content, or it may be implemented in a separate database.

In some embodiments, search server 160 also includes a context processing module 166 that is configured with various algorithms for processing received context to generate a context vector representative of the received content. In general, a context vector may include any data that represents all or part of the content. For example, one embodiment of a context vector for text content may include keywords such as terms (e.g., words or phrases) that appear in the content, and each such term may have an associated frequency count reflecting how many times that term occurs in the content. Other types of data may also be included, e.g., URLs or other data identifying any links that may be included in the content, the URL, or other identifier of the page that contains the content, category data associated with the content, or with a page that contains the content, and so on. In particular embodiments, contextual search makes use of these algorithms for processing received content.

In some embodiments, a content augmentation server 180 is also provided. Content augmentation server 180 communicates via Internet 140 with client application 125 to enhance the content of a web page being displayed with “special content” that is advantageously selected based on context vector data associated with the displayed page. In circumstances where the user has indicated an interest information related to a particular context, client application 125 transmits a context vector to content augmentation server 180 and content augmentation server 180 responds with special content to be added to a web page being displayed by client application 125.

In a particular embodiment, content augmentation server 180 and search server 160 are under common control, and content augmentation server 180 advantageously selects special content from sponsored content database 162. In another embodiment, content augmentation sever 180 may be independent of search server 160 an may have its own database of special content from which selections can be made based on context vectors provided by client application 125.

A content augmentation serve can be implemented in the same computer system as the search server or in a different serve rand the content augmentation server may communicate with a client system via the search server or independently of the search server. The content augmentation server maintains various data stores containing information and rules used to select special content given a particular context vector (or other representation of context data).

Other embodiments include user personalization features allowing data specific to the user as well as the context to inform the selection of search results, including contextual search results, and proposed transactions. For example, the search provider may maintain a user profile for each registered user of its services in a personalization database 167. When a registered user who is logged in executes a search (contextual or otherwise) or clicks through to a proposed transaction from a contextual search interface, information about that operation can be recorded and associated with the user. By analyzing patterns is a given user's behavior, a “user vector” may be developed, which can be used during search processing, e.g., in identifying and/or ranking search results. In some embodiments of the present invention, personalized search makes use of personalization database 167.

It will be appreciated that the search system described herein is illustrative and that variations and modifications are possible. The content sever, search server, and content augmentation sever systems may be part of a single organization, e.g., a distributed server system such as that provided to users by Google or Yahoo!. Or they may be part of disparate organizations. Each server system generally includes at least one server and an associated database system and may include multiple servers and associated database systems, which although shown as a signal block, may be geographically distributed.

For example, all servers of a search server system may be located in close proximity to one another (e.g., in a server farm located in a single building or campus) or they may be distributed at locations remote from one another (e.g., one or more servers located in city A and one or more servers located in City B). Thus, as used herein, a “server system” typically includes one or more logically and/or physically connected servers distributed locally or across one or more geographic locations. That is, the terms “server” and “server system” are used interchangeably.

The search server system may be configured with one or more page indexes and algorithms for accessing the page indexes and providing search results to users in response to search queries received from client systems. The search server system might generate the page indexes itself, receive page indexes from another source (e.g., a separate server system), or receive page indexes from another source and perform further processing thereof (e.g., addition or updating of the context identifiers).

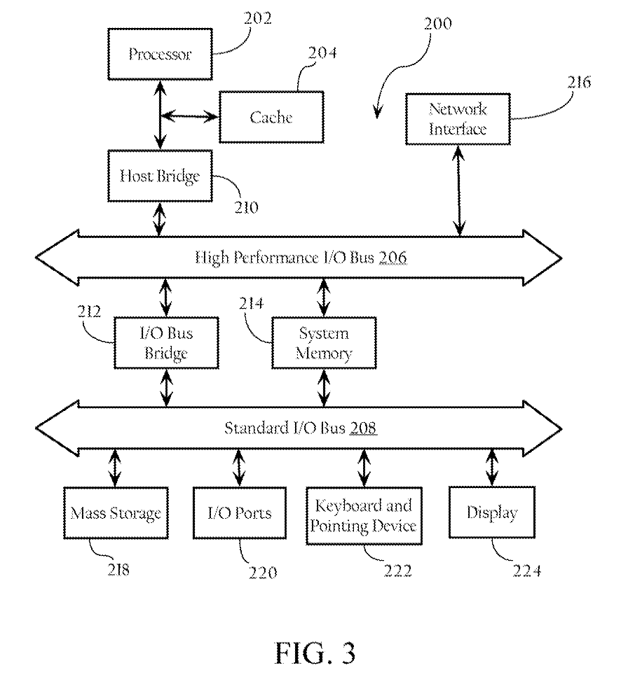

FIG. 3 illustrates, for didactic purposes, a hardware system 200, which might be used to implement a search-engine server such as a content serve, a search server, or a content augmentation server or to implement a client computing device such as a laptop or desktop. In one implementation, hardware system 200 comprises a processor 202, a cache memory 204, and one or more software applications and drivers directed to the function described herein. Additionally, hardware system 200 includes a high performance input/output (I/O) bus 206 and a standard I/O bus 208. A host bridge 210 couples processor 202 to high performance I/O bus 206, whereas I/O bus bridge 212 couples the two buses 206 and 208 to each other. A system memory 214 and a network/communication interface 216 couple to bus 206. Hardware system 200 may further include video memory (not shown) and a display device coupled to the video memory. Mass storage 218 and I/O ports 220 couple to bus 208. In one implementation, hardware system 200 may also include a keyboard and pointing device 222 and a display 224 coupled to bus 208. Collectively, the elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc. of Sunnyvale, Calif., as well as any other suitable processor.

The elements of hardware system 200 are described in greater detail below. In particular, network interface 216 provides communication between hardware system 200 and any of a wide range of networks, such as an Ethernet (e.g., IEEE 802.3) network, etc. Mass storage 218 provides permanent storage for the data and programming instructions to perform the above described functions implemented in the RF coverage map generator, whereas system memory 214 (e.g., DRAM) provides temporary storage for the data and programming instructions when executed by processor 202. I/O ports 220 are one or more serial and/or parallel communication ports that provide communication between additional peripheral devices, which may be coupled to hardware system 200.

Hardware system 200 may include a variety of system architectures; and various components of hardware system 200 may be rearranged. For example, cache 204 may be on-chip with processor 202. Alternatively, cache 204 and processor 202 may be packed together as a “processor module,” with processor 202 being referred to as the “processor core.” Furthermore, certain implementations of the present invention may not require nor include all of the above components. For example, the peripheral devices shown coupled to standard I/O bus 208 may couple to high performance I/O bus 206. In addition, in some implementations only a single bus may exist with the components of hardware system 200 being coupled to the single bus. Furthermore, hardware system 200 may include additional components, such as additional processors, storage devices, or memories.

In one embodiment, the processes described herein are implemented as a series of software routines run by hardware system 200. These software routines comprise a plurality or series of instructions to be executed by a processor in a hardware system, such as processor 202. Initially, the series of instructions are stored on a storage device, such as mass storage 218. However, the series of instructions can be stored on any suitable storage medium, such as a diskette, CD-ROM, ROM, EEPROM, etc. Furthermore, the series of instructions need not be stored locally, and could be received from a remote storage device, such as a server on a network, via network/communication interface 216. The instructions are copied from the storage device, such as mass storage 218, into memory 214 and then accessed and executed by processor 202.

An operating system manages and controls the operation of hardware system 200, including the input and output of data to and from software applications (not shown). The operating system provides an interface between the software applications being executed on the system and the hardware components of the system. According to one embodiment of the present invention, the operating system is the Linux operating system. However, the present invention may be used with other suitable operating systems, such as the Windows® 95/98/NT/XP operating system, available from Microsoft Corporation of Redmond, Wash., the Apple Macintosh Operating System, available from Apple Computer Inc. of Cupertino, Calif. UNIX operating systems, and the like.

### D. URL Redirection or Forwarding

URL redirection or URL forwarding is a technique for making a web page available under multiple URLs. There are several reasons why a web engineer might use redirection. Currently, web engineers tend to pass descriptive attributes in the actual URL to represent data hierarchies, command structures, transaction paths, and session information. This practice results in a URL that is aesthetically displeasing and difficult to remember. So a web engineer might create and register a simpler URL that is redirected to the actual URL when a suer clicks or enters the simpler URL. Similarly, stale links to an old URL can be redirected to a new web page, using URL redirection. These links might be from other sites or from bookmarks/favorites that users have stored with their browsers. The stale links might have even been stored by a search engine.

### E. Processes for Visually Emphasizing Results

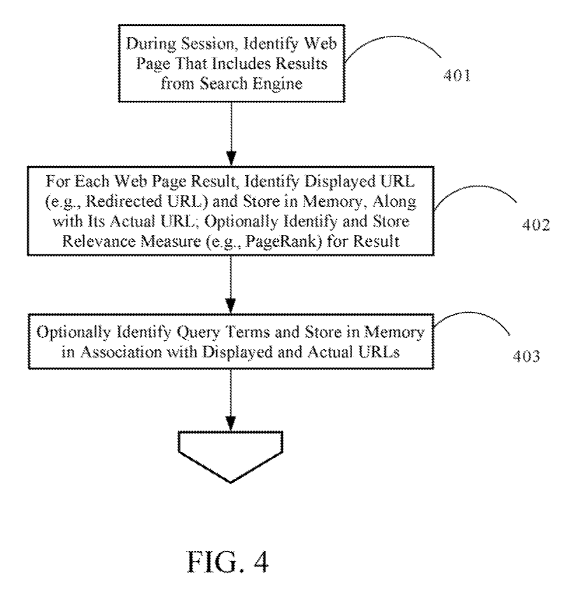

FIG. 4 is a diagram showing a flowchart of a process used for storing query results in memory, which process might be used in an embodiment of the present invention. In a particular embodiment of the present invention, this process might comprise a module or part of a module in a search toolbar or other client-side program on a computing system such as a desktop/laptop computer. In other embodiments, this process might comprise a module or part of a module in a server-side program. In the first step 401, the process monitors web pages returned to a web browser during a user session and identifies a web page that includes results (e.g., in the page's HTML) form a search engine such as Google or Yahoo!. Then in step 402, the process iterates over each of the returned results, identifying and storing in memory each result's displayed (e.g., redirected) URL, along with its actual URL. Also, in step 402, the process might optionally identify and store the relevance measure (e.g., PageRank) for each result. Then in step 403, the process might optionally identify and store in memory, in association with the displayed and actual URLs, the query terms included in the web page, if such query terms were not already previously stored (e.g., upon use entry) by another module of the search toolbar or client-side program.

It will be appreciated that the process shown in FIG. 4 involves a user session and consequently does not employ any form of persistent storage, e.g., the displayed URLs are stored in memory rather than a file. Other embodiments might make use of files (e.g., temporary files) or of a system database such as the Windows registry.

Also, it will be appreciated that there might be a trivial difference between displayed URLs, where, in this context, the term “trivial” refers to the effect on the probability of clicking. Consequently, some embodiments might not make use of URLs, but rather some identifier used in the search engine's index, such as a singleprint/fingerprint (see U.S. Patent Application Publication No. 20050210043), or other identifier which makes client-side processing simpler and more precise.

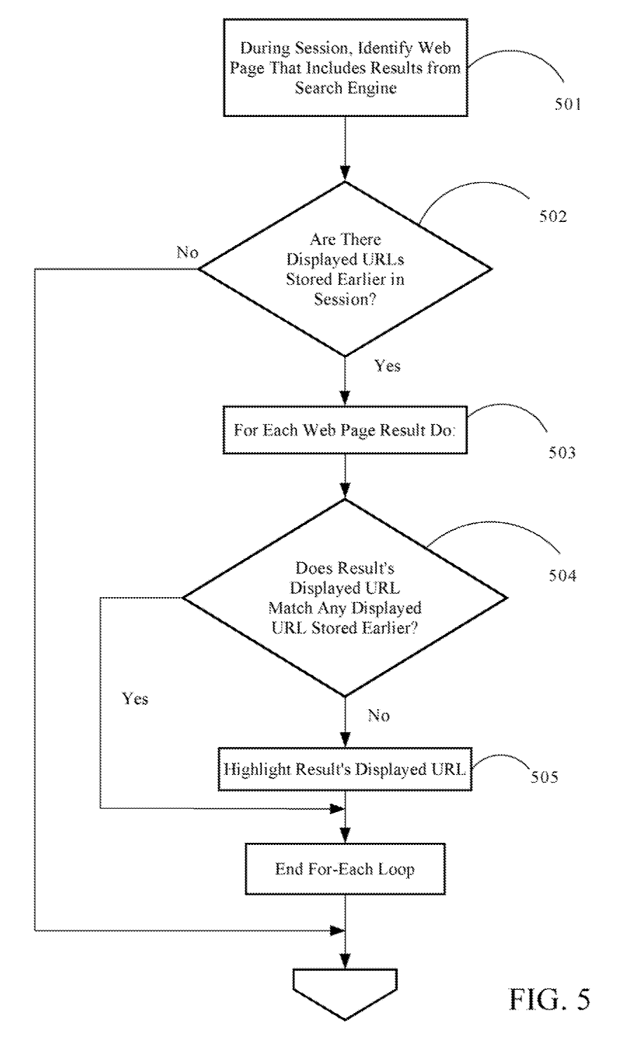

FIG. 5 is a diagram showing a flowchart of a process used for visually emphasizing query results on the basis of previously-returned URLs, which process might be used in an embodiment of the present invention. Here again, this process might comprise a module or part of a module in a search toolbar or the client-side program on a computing system such as a desktop/laptop computer, in a particular embodiment. In other embodiments, this process might comprise a module or part of a module in a server-side program. In the first step 501, the process monitors web pages returned to a web browser during a user session and identifies a web page that includes results from a search engine (as in step 401). Then in step 502, the process determines whether there are any displayed URLs stored earlier in the session (e.g., in step 402). If not, the process skips the process shown in FIG. 5 and simply performs the process shown in FIG. 4. Otherwise, the process goes to step 503 and creates an iteration over each search-engine result returned in the web page. In the first step of this iteration, step 504, the process determines whether the result's displayed URL matches any displayed URL stored earlier in the session (e.g., in step 402). If so, the process ends for that result. Otherwise, if the displayed URL does not match any stored URLs, the process goes to step 505, the last step in the iteration, and highlights the displayed URL for the result in the web page to be presented to the user. Once the iteration completes, the process ends.

In step 505 of the process shown in FIG. 5, the process highlights the displayed URL for a search-engine result. As used here, “highlight” means any sort of visual emphasis, including changing the background color in a rectangle that encompasses the displayed URL, using boldface or italics font for the displayed URL, etc. To achieve such highlighting in a web page to be presented to the user, a particular embodiment might use a server-side program that inserts “commented-out” tags into the web page's results, which tags a module in a search toolbar or client-side program uncomments if no matching URL is found. Alternatively, if step 504 is performed by a module in a server-side program, the module might insert a tag identifying an unmatched URL, which tag a search toolbar or client-side program might then use to add highlighting.

Alternatively, one might “highlight” a displayed URL by reducing the number of other URLs displayed along with it. So, for example, if a web page includes both displayed URLs from organic search and displayed URLs from sponsored search, an embodiment might reduce the number of the displayed URLs from sponsored search in order to highlight or enhance the highlighting of a displayed URL from organic search. In a similar way, an embodiment might highlight a displayed URL by contracting the sections of the web page that do not contain the displayed URL.

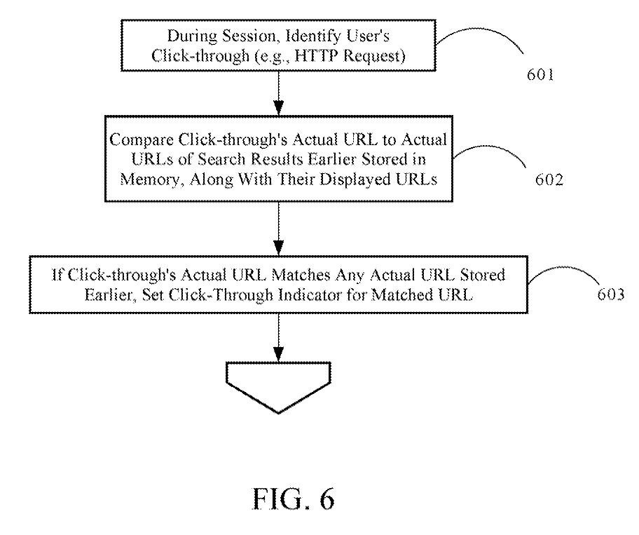

FIG. 6 is a diagram showing a flowchart of a process used for storing click-though data in memory, which process might be used in an embodiment of the present invention. In the first step 601, the process identifies a click-through during a user session, for example, by monitoring the HTTP requests emanating from a browser. The in step 602, the process compares the click-through's actual URL to the actual URLs of search results which were earlier stored in memory along with their displayed URLs (e.g., in step 402). If the click-through's actual URL matches any actual URL stored earlier, the process sets a click-through indicator for the matched URL, in step 603.

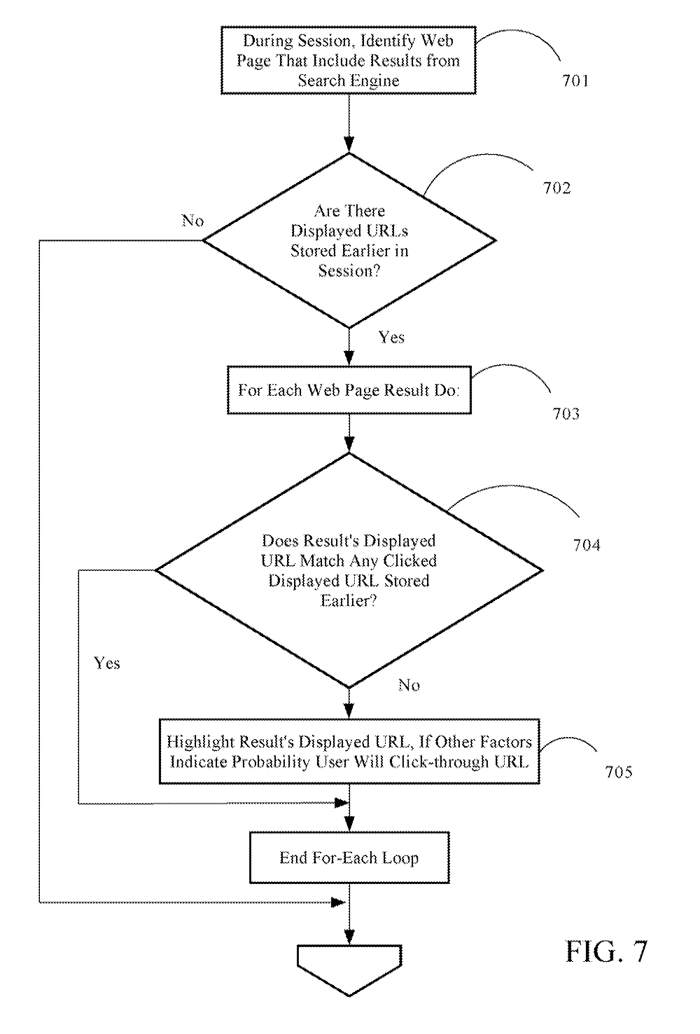

FIG. 7 is a diagram showing a flow chart of a process used for visually emphasizing query results on the basis of previously-stored click-throughs, which process might be used in an embodiment of the present invention. In the first step 701, the process monitors web pages returned to a web browser during a user session and identifies a web page that includes results from a search engine (as in step 401). In step 702, the process determines whether there are any displayed URLs that were stored earlier in the session. If not, the process skips the process shown in FIG. 7 and simply performs the process shown in FIG. 4. Otherwise, if there are stored URLs, the process goes to step 703 and iterates over each result in the web page. In the first step of this iteration, step 704, the process determines whether the results displayed URL matches any displayed URL that was stored and clicked earlier. If so, the process ends for that result. Otherwise, it further was no match, the process goes to step 705, the last step in the iteration, and highlights the displayed URL for the result, if other factors indicate a probability that the user will click-through the displayed URL. Once the iteration completes, the process ends.

In step 705, the process does not highlight all displayed URLs that have not been clicked, since this might be a relatively large number, although alternative embodiments might do so. Rather, the process highlights a displayed URL which has not been clicked if other factors indicate a probability that the user will click-through the displayed URL. In some embodiments, the other factors in step 705 might comprise contextual information obtained from the user during the same or previous sessions. Also in some embodiments, these other factors might comprise personalization information obtained from the user during the same or previous sessions. As to such contextual and personalization information, see U.S. Patent Application Publication Nos. 20060026013 and 20060167857, which are commonly-owned and whose disclosures are incorporated herein by reference in their entirety for all purposes. Also, as to personalization information, see U.S. Patent Application Publication No. 20050240580. Additionally, these other factors might comprise a computed probability resulting from a maximum entropy model. See E. Manavoglu, D. Pavlov. C. Lee Giles, Probabilistic User behavior Models, Proceedings of the Third IEEE International Conference on Data Mining (2003).

Further, in determining whether the there is a probability that the user will click-through the displayed URL, in step 705, the process might, for example, compare the displayed URL's probability to: (1) the probabilities for other displayed URLs in the current result set being clicked; (2) the typical probability (e.g., median or mean probability), across users, of clicking on the displayed URL, which typical probability might be maintained and returned by the server; or (3) the other click-probability estimates generated so far in the current session.

In another embodiment, a process might use stored click-throughs to de-emphasize a displayed URL. For example, if the user clicks through the same displayed URL multiple times, the process might de-emphasize the displayed URL in a manner consistent with human-factors analysis, e.g., by expanding the section of the web page that do not contain the displayed URL.

Other embodiments might use a result's relevance measure (e.g., its PageRank) or ranking (e.g., 1, 3, 8, etc.) along with query similarity, as a basis for selecting a result for highlighting. In this regard, recall that in steps 402 and 403 in FIG. 4, the process optionally identifies and stores the relevance measure for each result in the web page's result set and the terms of the query tat generated the result set. Such stored query terms might be used to determine similarity with a later query, using key-work matching or a more sophisticated method involving semantic relatedness. See Ji-Rong Wen, Jian-Yun Nie, HongJiang Zhang, Query Clustering Using User Logs, ACM Trans. Information Systems (Vol. 20 No. 1) (2002). Then using the stored relevance measure for each result, a process might highlight the displayed URL for a result that (a) matches a stored displayed URL and (b) whose relevance measure has climbed by some pre-defined amount, (c) if the result's query were similar enough to the stored query.

Further, in particular embodiments, the relevance measure might be a combination of a query-independent (sometimes called “static”) score and a query-dependent (sometimes called “dynamic”) score. Here it will be appreciated that PageRank, as originally set forth, is an example of a query-independent score. Another example, which pre-dates PageRank, is the query-independent score using “inlinks” described in Peter Pirolli, James Pitkow, and Ramana Rao, Silk from a Sow's Ear: Extracting Usable Structures from the Web, Conference on Human Factors in Computing Systems (1996). In some embodiments, a query-independent score might include other attributes such as a flag indicating whether the page is present in an editorially screened directly. Also, in some embodiments, a query-dependent score might include: (a) the number of times the query words were mentioned; (b) flags indicating the sections of the page in which the terms appear; or (c) proximity scores indicating how spatially close the terms occur.

Particular embodiments of the processes described above might be comprised of instructions that are stored on storage media. The instructions might be retrieved and executed by a processing system. The instructions are operational when executed by the processing system to direct the processing system to operate in accord with the present invention. Some examples of instructions are software, program code, firmware, and microcode. Some examples of storage media are memory devices, tape, disks, integrated circuits, and servers. The term “processing system” refers to a single processing device or a group of inter-operational processing devices. Some examples of processing devices are integrated circuits and logic circuitry. Those skilled in the art are familiar with instructions, storage media, and processing systems.

Those skilled in the art will appreciate variations of the above-described embodiments that fall within the scope of the invention. In this regard, it will be appreciated that there are many possible orderings of the steps in the processes described above and many possible allocations of those steps between (a) client-side modules or programs, (b) server-side modules or programs, or (c) client-side and server-side modules or programs. As a result, the invention is not limited to the specific examples and illustration discussed above, but only by the following claims and their equivalents.

What is claimed is:

1. A method, comprising:
accessing a web page which includes one or more results returned by an information-retrieval system, wherein each result includes a displayed URL;
determining whether the displayed URL matches one or more stored URLs, wherein the one or more stored URLs were included in one or more results returned earlier by the information-retrieval system; and
visually emphasizing the displayed URL when presenting the web page to a user at a client computing device, if the displayed URL does not match any stored URL.

2. A method according to claim 1, wherein the one or more stored URLs are stored in main memory.

3. A method according to claim 1, wherein the information-retrieval system is a search engine.

4. A method according to claim 1, wherein the visual emphasis comprises changing the background color in a rectangle that encompasses the displayed URL.

5. A method, comprising:
identifying a web page which includes one or more results returned by an information-retrieval system, wherein each result includes a displayed URL;
determining whether the displayed URL matches one or more stored URLs which have been clicked through by a user, wherein the one or more stored URLs were included in one or more results returned earlier by the information-retrieval system and wherein an indication of a click-through by the user was detected and stored; and
visually emphasizing the displayed URL when presenting the web page to a user at a client computing device, if the displayed URL does not match any stored URL which has been clicked through by the user and other factors indicate a probability that the user will click-through the displayed URL.

6. A method according to claim 5, wherein the one or more stored URLs is stored in main memory, along with the indication of a click-through by the user.

7. A method according to claim 5, wherein the indication of a click-through was detected by monitoring one or more HTTP requests emanating from a browser and wherein each HTPP request includes an actual URL.

8. A method according to claim 7, wherein the one or more stored URLs is a redirected URL associated with an actual URL which is also stored in memory and the actual URL in the one or more HTTP requests is matched to an actual URL stored in memory.

9. A method according to claim 5, wherein the other factors indicating a probability of click-through comprise contextual information obtained from the user.

10. A method according to claim 5, wherein the other factors indicating a probability of click-through comprise personalization information obtained from the user.

11. A method according to claim 5, wherein the other factors indicating a probability of click-through comprise a calculation resulting from a maximum entropy model.

12. An apparatus, comprising
a network interface;
main memory;
one or more processors; and
logic encoded in one or more computer-readable media for execution and when executed operable to:
access a web page which includes one or more results returned by an information-retrieval system, wherein each result includes a displayed URL;
determine whether the displayed URL matches one or more stored URLs, wherein the one or more stored URLs were included in one or more results returned earlier by the information-retrieval system; and
visually emphasize the displayed URL when presenting the web page to a user at a client computing device, if the displayed URL does not match any stored URL.

13. An apparatus according to claim 12, wherein the one or more stored URLs are stored in main memory.

14. An apparatus according to claim 12, wherein the information-retrieval system is a search engine.

15. An apparatus according to claim 12, wherein the visual emphasis comprises changing the background color in a rectangle that encompasses the displayed URL.

16. An apparatus, comprising
a network interface;
main memory;
one or more processors; and
logic encoded in one or more computer-readable media for execution and when executed operable to:
access a web page which includes one or more results returned by an information-retrieval system, wherein each result includes a displayed URL;
determine whether the displayed URL matches one or more stored URLs which have been clicked through by a user, wherein the one or more stored URLs were included in one or more results returned earlier by the information-retrieval system and wherein an indication of a click-through by the user was detected and stored; and
visually emphasize the displayed URL when presenting the web page to a user at a client computing device, if the displayed URL does not match any stored URL which has been clicked through by the user and other factors indicate a probability that the user will click-through the displayed URL.

17. An apparatus according to claim 16, wherein the one or more stored URLs is stored in main memory, along with the indication of a click-through by the user.

18. An apparatus according to claim 16, wherein the indication of a click-through was detected by monitoring one or more HTTP requests emanating from a browser and wherein each HTPP request includes an actual URL.

19. An apparatus according to claim 18, wherein the one or more stored URLs is a directed URL associated with an actual URL which is also stored in memory and the actual URL in the one or more HTTP request is matched to an actual URL stored in memory.

20. An apparatus according to claim 16, wherein the other factors indicating a probability of click-through comprise contextual information obtained from the user.

21. An apparatus according to claim 16, wherein the other factors indicating a probability of click-through comprise personalization information obtained from the user.

22. An apparatus according to claim 16, wherein the other factors indicating a probability of click-through comprise a calculation resulting from a maximum entropy model.
